(19) United States
(12) Patent Application Publication
(10) Pub. No.: US 2015/0249955 A1
(43) Pub. Date: Sep. 3, 2015

(54) Dialling method and device

(71) Applicant: ZTE CORPORATION, Shenzhen, Guangdong (CN)

(72) Inventor: Xiangyang Yan, Shenzhen (CN)

(21) Appl. No.: 14/427,705

(22) PCT Filed: Jul. 12, 2013
(86) PCT No.: PCT/CN2013/079325

§ 371 Date: Mar. 12, 2015

(30) Foreign Application Priority Data
Sep. 13, 2012 (CN) 201210338541.6

(51) Int. Cl. H04W 48/00; G06F 3/0482; G06F 3/0484; H04W 12/06

(52) U.S. Cl. CPC H04W 48/17; H04W 12/06; G06F 3/0482; G06F 3/04842; H04W 84/12

(57) ABSTRACT

Provided is a dialling method, which includes: acquiring a list of hot spots, and setting strategy configuration information corresponding to hot spots; displaying a user interface for user selection according to the strategy configuration information; and executing dialling access according to the selection of the user. A dialling device is also provided.

### TECHNICAL FIELD

The disclosure relates to the field of mobile communication, in particular to a dialling method and device.

### BACKGROUND

Along with the popularization of Wireless Fidelity (WIFI) technology, more and more users can access the Internet more conveniently without the constraint of cable. At present, most of users at home access an operator network to further access the Internet by virtue of the Asymmetric Digital Subscriber Line (ADSL) technology. At the same time, along with the development of the WIFI technology, an ADSL access box is endowed with a function of a WIFI hot spot so as to meet requirements of the users on WIFI Internet access with mobile terminals at home, and such a WIFI-enabled ADSL access box is usually called “wireless home gateway”, which is referred to as “home gateway” for short below.

In the related art, regardless of a home gateway hot spot or a WIFI hot spot deployed by an operator, the user needs to be identified for access to the Internet. An account and a password are usually required for authentication, and the user enjoys network service by inputting the account information. At present, there are mainly the following user authentication manners supported by the hot spot deployed by the operator in a city: Extensible Authentication Protocol-Subscriber Identity Module (EAP-SIM) authentication, Extensible Authentication Protocol-Authentication and Key Agreement (EAP-AKA) authentication, telecommunication C+W (Code Division Multiple Access+Wireless Local Area Network (CDMA+WLAN)) authentication and the like. A mobile phone acquires a Subscriber Identity Module (SIM) or Universal Subscriber Identity Module (USIM) as the account information, such as an International Mobile Subscriber Identity (IMSI) and a Mobile Equipment Identifier (MEID), and interacts with the network to implement authentication for the Internet access of the user under a specific format protocol. For the home gateway hot spot, a Point-to-Point Protocol over Ethernet (PPPOE) manner of dialling authentication is usually adopted. Due to the various types of hot spots, it is difficult for the user to distinguish different types of hot spots, let alone select a hot spot and an authentication manner for connection and determine how to access the Internet after being connected with the hot spot, and the like.

### SUMMARY

A main purpose of the embodiment of the disclosure is to provide a dialling method and device, so as to solve the problem of tedious and complex network dialling connection and improve a user experience.

The embodiment of the disclosure discloses a dialling method, which includes:

acquiring a list of hot spots, and setting strategy configuration information corresponding to hot spots;

displaying a user interface for a user to select according to the strategy configuration information; and

executing dialling access according to the selection of the user.

Preferably, the method further includes: in a dialling access process, displaying dialling connection status prompt information in real time.

Preferably, the step of acquiring the list of hot spots and setting the strategy configuration information corresponding to the hot spots specifically includes:

when the list of hot spots includes a plurality of types of hot spots, performing authentication classification on the hot spots according to a preset rule; and

setting strategy configuration information corresponding to the hot spots according to authentication types.

Preferably, the step of executing dialling access according to the selection of the user specifically includes:

searching the list of hot spots for an access hot spot selected by the user;

if there is the access hot spot selected by the user, picking up the access hot spot, and loading the strategy configuration information corresponding to the access hot spot;

displaying a current user interface according to the strategy configuration information corresponding to the access hot spot; and

triggering dialling connection according to the authentication type of the access hot spot when the user clicks a connection button.

Preferably, the step of triggering dialling connection according to the authentication type of the access hot spot when the user clicks the connection button includes:

when the access hot spot is an access hot spot of a first authentication type, judging whether it is the first-time access of the access hot spot or not;

if it is the first-time access of the access hot spot, prompting the user to configure access information of the access hot spot; and

otherwise triggering dialling connection when the user clicks the connection button.

The embodiment of the disclosure also discloses a dialling device, which includes: a hot spot strategy selection module, an interface display module and a dialling access module, wherein

the hot spot strategy selection module is configured to acquire a list of hot spots, and set strategy configuration information corresponding to hot spots;

the interface display module is configured to display a user interface for a user to select according to the strategy configuration information set by the hot spot strategy selection module; and

the dialling access module is configured to execute dialling access according to the selection of the user.

Preferably, the interface display module is further configured to, in a dialling access process, display dialling connection status prompt information in real time.

Preferably, the hot spot strategy selection module is specifically configured to, when the list of hot spots includes a plurality of types of hot spots, perform authentication classification on the hot spots according to a preset rule, and set strategy configuration information corresponding to the hot spots according to authentication types.

Preferably, the dialling access module includes:

an access hot spot searching unit, configured to search the list of hot spots for an access hot spot selected by the user;

a configuration information loading unit, configured to, if there is the access hot spot selected by the user in the list of hot spots, pick up the access hot spot, and load the strategy configuration information corresponding to the access hot spot; and

a dialling connection unit, configured to trigger dialling connection according to the authentication type of the access hot spot when the user clicks a connection button.

Preferably, the interface display module is further configured to display a current user interface according to the strategy configuration information of the access hot spot.

Preferably, the dialling connection unit is specifically configured to, when the access hot spot is an access hot spot of a first authentication type, judge whether it is the first-time access of the access hot spot or not; if it is the first-time access of the access hot spot, prompt the user to configure access information of the access hot spot; otherwise trigger dialling connection when the user clicks the connection button.

According to the embodiment of the disclosure, by the method of acquiring the list of hot spots, setting the strategy configuration information corresponding to the hot spots, displaying the user interface according to the strategy configuration information and executing dialling access according to the selection of the user, a beneficial effect of enabling the user to simply and rapidly dial to access the Internet is achieved, a dialling connection speed is increased, meanwhile, a difficulty in dialling connection is greatly lowered, a user experience is improved, and great convenience is brought to the Internet enjoyment of the user.

### BRIEF DESCRIPTION OF THE DRAWINGS

FIG. 1 is a structure diagram of a dialling device according to an embodiment of the disclosure;

FIG. 2 is a diagram of a user interface displayed by a dialling device according to an embodiment of the disclosure;

FIG. 3 is a structure diagram of a dialling access module in a dialling device according to an embodiment of the disclosure;

FIG. 4 is a flowchart of a dialling method according to a first embodiment of the disclosure;

FIG. 5 is a flowchart of a dialling method according to a second embodiment of the disclosure; and

FIG. 6 is a flowchart of the execution of dialling access according to the selection of a user in a dialling method according to an embodiment of the disclosure.

The purposes, features and an advantages of the embodiments of the disclosure are further described with reference to the embodiments and the drawings.

### DETAILED DESCRIPTION

Technical solutions of the embodiment of the disclosure are further described below with reference to the drawings and the specific embodiments. It should be understood that the specific embodiments are provided to explain the embodiment of the disclosure and not intended to limit the scope of the disclosure.

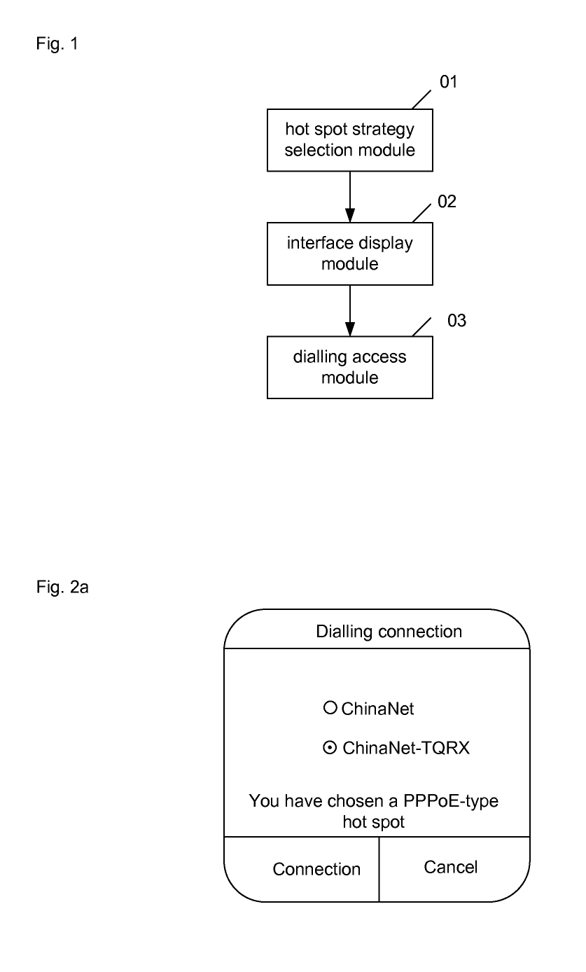

FIG. 1 is a structure diagram of a dialling device according to an embodiment of the disclosure. As shown in FIG. 1, the dialling device according to the embodiment of the disclosure specifically includes a hot spot strategy selection module 01, an interface display module 02 and a dialling access module 03.

The hot spot strategy selection module 01 is configured to acquire a list of hot spots, and set strategy configuration information corresponding to a hot spot.

The hot spot strategy selection module 01 is specifically configured to acquire the list of hot spots, divide the hot spots into different types according to a preset rule, such as authentication types of the hot spots, when the list of hot spots includes a plurality of types of hot spots, and automatically generate the strategy configuration information corresponding to each strategy configuration option, wherein the strategy configuration information includes the types of the hot spots, authentication access manners and the like.

For example, China Telecom hot spots (including urban hot spots and home gateway hot spots) have different Service Set Identifier (SSID) names such as ChinaNet, ChinaNet_CW, ChinaNet_HomeCW and ChinaNet-random code, and thus the hot spot strategy selection module 01 can divide the hot spots into two different types of hot spots:

(1) C+W one-touch access: ChinaNet, ChinaNet_CW and ChinaNet_HomeCW; and

(2) PPPOE access: ChinaNet_random code;

The interface display module 02 is configured to display a user interface for user selection according to the strategy configuration information set by the hot spot strategy selection module 01.

The interface display module 02 is specifically configured to acquire the list of hot spots and the corresponding strategy configuration information from the hot spot strategy selection module 01, and draw and display the user interface. The user interface includes a dialling configuration option, a dialling disconnection button, dialling connection status display and the like, and is configured to prompt the user to perform simple configuration for dialling connection, and trigger a dialling connection flow and the like.

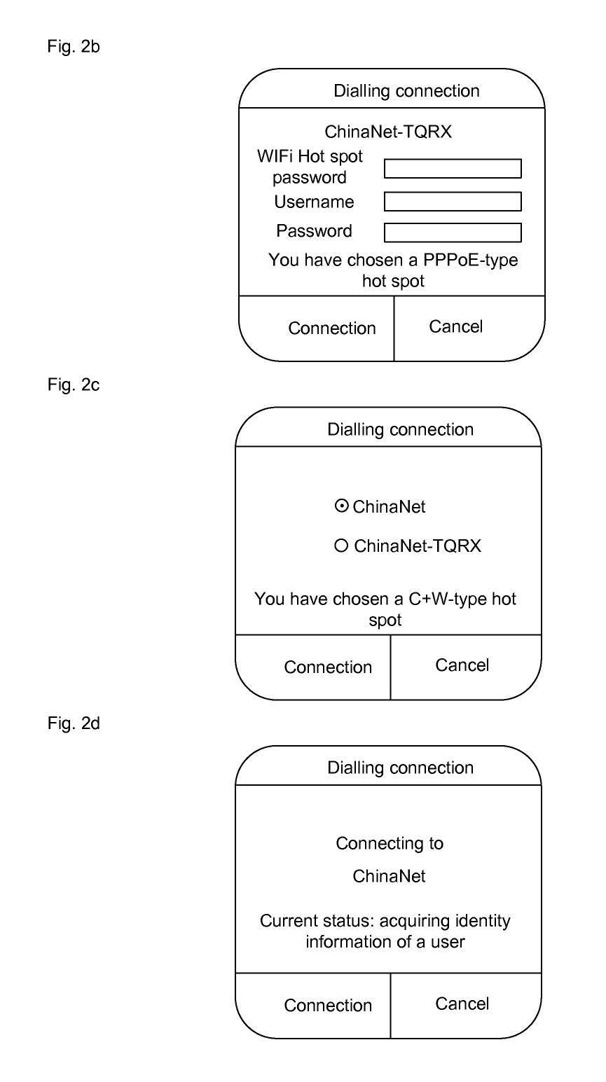

In a preferred embodiment, the user interface displayed by the interface display module 02 is shown in FIG. 2. The types of the hot spots that can be selected by the user for dialling connection are displayed for the user, and subsequent display is performed according to the selection of the user; particularly, the interface display module displays connection status prompt information in a dialling access process in real time.

The dialling access module 03 is configured to execute dialling access.

After the user finishes executing corresponding configuration and clicks the connection button on the displayed interface according to the corresponding authentication type, the dialling access module 03 executes and triggers the dialling connection flow, such as a PPPOE dialling flow, according to the corresponding authentication type. For example, the dialling access module 03 is specifically configured to feed back a real-time connection status to the interface display module 02 in real time while executing the dialling access flow; and correspondingly, the interface display module 02 is specifically configured to display the connection status prompt information fed back by the dialling access module 03 in real time, so that the user can learn the whole dialling access progress.

According to the embodiment, the list of hot spots is acquired, the strategy configuration information corresponding to the hot spots is set, the user interface is displayed according to the strategy configuration information, and dialling access is executed according to the selection of the user, so that the beneficial effect of enabling the user to simply and rapidly dial to access the Internet is achieved, and the dialling connection speed is increased; meanwhile, the difficulty in dialling connection is greatly lowered, the user experience is improved, and great convenience is brought to the Internet enjoyment of the user.

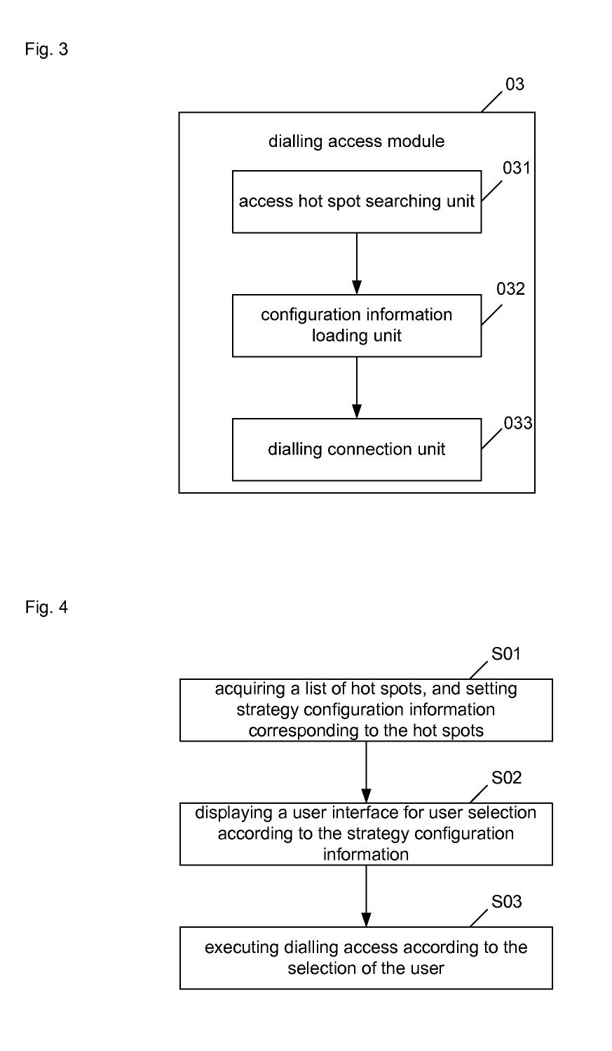

As shown in FIG. 3, FIG. 3 is a structure diagram of a dialling access module in a dialling device according to an embodiment of the disclosure; and the embodiment only further describes the dialling access module 03, and other related modules of the dialling device according to the embodiment of the disclosure may be referred to specific description in the related embodiment, and will not be repeated here.

The dialling access module 03 includes: an access hot spot searching unit 031, a configuration information loading unit 032 and a dialling connection unit 033.

The access hot spot searching unit 031 is configured to search a list of hot spots, for an access hot spot selected by a user.

The access hot spot searching unit 031 searches for the list of hot spots currently consistent with a configuration condition of the user according to a dialling access configuration selected in an interface display module 02 by the user, and judges whether there is the access hot spot selected by the user in the found list of hot spots or not.

The configuration information loading unit 032 is configured to, if there is the access hot spot selected by the user in the list of hot spots, select the access hot spot, and load the strategy configuration information corresponding to the access hot spot; and

if the access hot spot searching unit 031 finds the access hot spot selected by the user from the list of hot spots, the configuration information loading unit 032 selects the access hot spot selected by the user from the list of hot spots, and loads the strategy configuration information corresponding to the access hot spot according to the access hot spot.

The dialling connection unit 033 is configured to trigger dialling connection according to an authentication type of the access hot spot when the user clicks a connection button.

According to hot spot configuration information of the access hot spot and related information of the access hot spot, which are loaded by the configuration information loading unit 032, the interface display module 02 displays a corresponding current user interface; when the access hot spot selected by the user is an access hot spot of a first authentication type, such as a PPPOE-type hot spot, the dialling connection unit 033 judges whether it is the first-time access to the access hot spot or not; if it is the first-time access to the access hot spot, the user interface displayed by the interface display module 02 is as shown in FIG. 2b, prompting the user to input corresponding access information such as a hot spot password, a username and a password during the first connection; during the subsequent access to the access hot spot of the first authentication type, it is unnecessary to input the information such as the username and the password on the display interface as shown in FIG. 2b, and the dialling connection unit 033 can trigger a dialling connection flow after the user clicks the connection button; and after the dialling connection unit 033 triggers the dialling connection flow, a dialling connection status is as shown in FIG. 2d. If the access hot spot selected by the user is an access hot spot of any other authentication type than the access hot spot of the first authentication type, for example, the user selects a C+W-type hot spot as shown in FIG. 2c, it is unnecessary to display the user configuration page as shown in FIG. 2b, and after the user clicks the connection button, it directly proceeds with the dialling connection flow as shown in FIG. 2d.

According to the embodiment, dialling access is executed according to the selection of the user, so that the beneficial effect of flexibly realizing dialling connection according to an actual configuration of the user is achieved, the problem that the user located in an environment without a related hot spot cannot access the Internet is solved, and the user experience is further improved.

FIG. 4 is a flowchart of a dialling method according to a first embodiment of the disclosure, and as shown in FIG. 4, the dialling method includes the following steps:

Step 01: acquiring a list of hot spots, and setting strategy configuration information corresponding to hot spots, wherein

specifically, a hot spot strategy selection module acquires the list of hot spots, divides the hot spots into different types according to a preset rule such as authentication types of the hot spots when the list of hot spots includes a plurality of types of hot spots, and automatically generates the strategy configuration information of corresponding strategy configuration options.

For example, China Telecom hot spots (including urban hot spots and home gateway hot spots) have different SSID names such as ChinaNet, ChinaNet_CW, ChinaNet_HomeCW and ChinaNet-random code, and thus the hot spot strategy selection module can divide the hot spots into two different types of hot spots:

(1) C+W one-touch access: ChinaNet, ChinaNet_CW and ChinaNet_HomeCw; and

(2) PPPOE access: ChinaNet_random code.

Step 02: displaying a user interface for user selection according to the strategy configuration information, wherein

an interface display module acquires the list of hot spots and the corresponding strategy configuration information from the hot spot strategy selection module, and draws and displays the user interface, and the user interface includes a dialling configuration option, a dialling disconnection button, dialling connection status display and the like, and is configured to prompt the user to perform simple configuration on dialling connection, trigger a dialling connection flow and the like.

In a preferred embodiment, the displayed user interface is as shown in FIG. 2, and as shown in FIG. 2, the display module displays the type of the hot spot required to be selected by the user for dialling connection to the user, and subsequent display is performed according to the selection of the user.

Step 03: executing dialling access according to the selection of the user.

After the user finishes corresponding configuration and clicks connection on the displayed interface, a dialling access module executes and triggers the dialling connection flow, such as a PPPOE dialling flow, according to the corresponding authentication type.

In a preferred embodiment, the dialling access flow is specifically as follows:

the list of hot spots is searched according to the access hot spot selected by the user, and whether there is the access hot spot selected by the user in the list of hot spots or not is judged; if there is the access hot spot selected by the user in the list of hot spots, the access hot spot is picked up, and the strategy configuration information corresponding to the access hot spot is loaded according to the access hot spot; the corresponding user interface is drawn and displayed according to the access hot spot and the strategy configuration information corresponding to the access hot spot; and for the specific user interface, the specific description of the embodiment as shown in FIG. 2 may be referred to, which will not be repeated here.

The step of triggering dialling connection according to the authentication type of the access hot spot selected by the user when the user clicks a connection button includes that: when the access hot spot is an access hot spot of a first authentication type, such as a PPPOE-type access hot spot, it is necessary to judge whether it is the first-time access to the access hot spot or not; and if it is the first-time access to the access hot spot, the user is prompted to configure access information, such as an access hot spot account and a password, of the access hot spot on the displayed interface as shown in FIG. 2b, and after the user clicks the connection button, the dialling connection flow is triggered; and

if the user selects an access hot spot of an authentication type other than the first authentication type, such as a C+W-type hot spot, on the interface as shown in FIG. 2c, it is unnecessary to perform configuration as shown in FIG. 2b, and after the user clicks the connection button, the dialling connection is directly triggered.

According to the embodiment, by the method of acquiring the list of hot spots, setting the strategy configuration information corresponding to the hot spots, displaying the user interface according to the strategy configuration information and executing dialling access according to the selection of the user, the beneficial effect of enabling the user to simply and rapidly dial to access the Internet is achieved, the dialling connection speed is increased, meanwhile, the difficulty in dialling connection is greatly lowered, the user experience is improved, and great convenience is brought to the Internet enjoyment of the user.

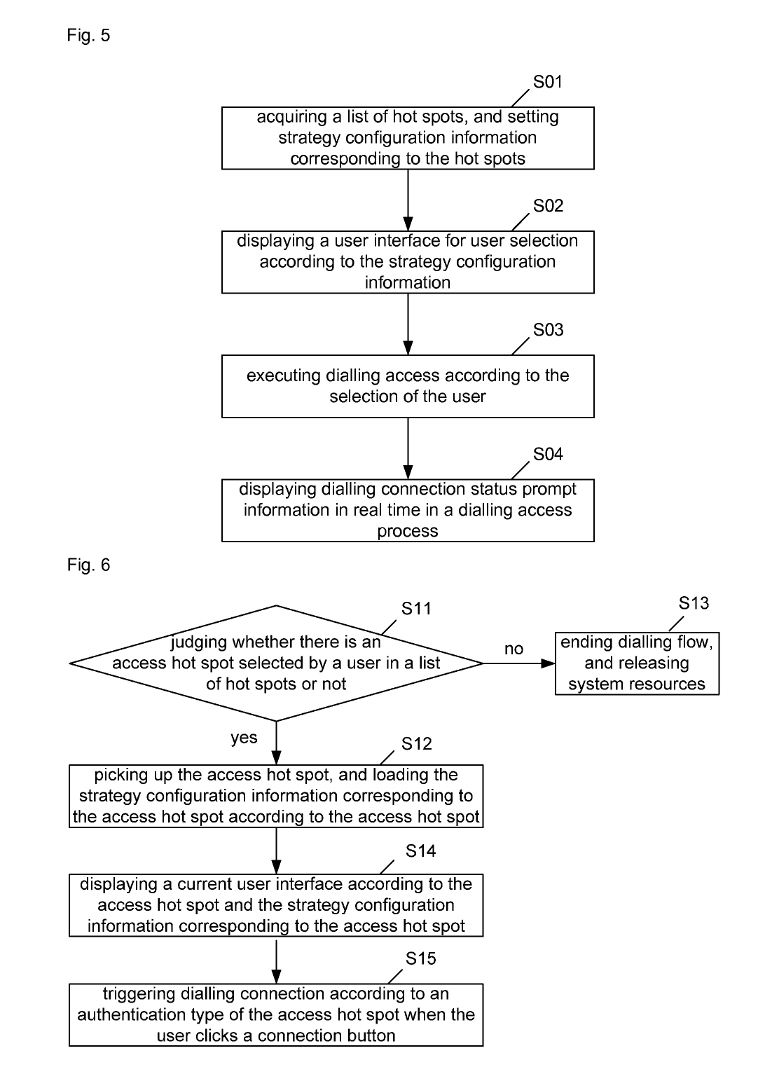

As shown in FIG. 5, FIG. 5 is a flowchart of a dialling method according to a second embodiment of the disclosure; the only one difference between the second embodiment and the first embodiment is that Step 04 is added; and in this embodiment, only Step 04 is specifically described, and for other related steps of the dialling method according to the embodiment of the disclosure, specific description in the related embodiment may be referred to, which will not be repeated here.

As shown in FIG. 5, after Step 03, the dialling method according to the embodiment of the disclosure further includes:

Step 04: displaying dialling connection status prompt information in real time during a dialling access process.

A dialling access module executes a dialling access flow, and simultaneously feeds back a status to an interface display module, the interface display module displays the dialling connection status prompt information to prompt a user in real time, so that the user can clearly know the whole real-time dialling access process according to the prompt information.

According to the embodiment, by the method of displaying the dialling connection status prompt information in real time during the dialling access process, a beneficial effect of enabling the user to know a dialling access status in real time is achieved, system performance is improved, and the user experience is further improved.

As shown in FIG. 6, FIG. 6 is a flowchart of the execution of dialling access according to the selection of a user in a dialling method according to an embodiment of the disclosure; and in the embodiment, only Step 03 is described here, and for other related steps of the dialling method according to the embodiment of the disclosure, specific description in related embodiments may be referred to, which will not be repeated here.

As shown in FIG. 6, Step 03 in the dialling method according to the embodiment of the disclosure specifically includes:

Step 11: searching a list of hot spots for an access hot spot selected by a user; if there is the access hot spot selected by the user in the list of hot spots, executing Step 12; otherwise, executing Step 13, wherein

the list of hot spots currently consistent with a configuration condition of the user is searched for according to the access hot spot selected by the user, and whether there is the access hot spot selected by the user in the found list of hot spots or not is judged;

Step 12: picking up the access hot spot, loading strategy configuration information corresponding to the access hot spot according to the access hot spot, and executing Step 14;

Step 13: ending a dialling flow, releasing system resources, and ending the process flow.

If the access hot spot selected by the user can be found from the found list of hot spots, the access hot spot is picked up, meanwhile, the strategy configuration information corresponding to the access hot spot is loaded according to the access hot spot, and the access hot spot and the strategy configuration information corresponding to the access hot spot are provided for an interface display module to draw and display a currently required user interface; and if the access hot spot selected by the user cannot be found after the list of hot spots is traversed, the current dialling flow is ended, and the system resource is released.

Step 14: displaying the current user interface according to the access hot spot and the strategy configuration information corresponding to the access hot spot.

The interface display module draws and displays the current corresponding user interface for the subsequent operation of the user according to the access hot spot and the strategy configuration information corresponding to the access hot spot, which are picked up; and

Step 15: triggering dialling connection according to an authentication type of the access hot spot when the user clicks a connection button.

The authentication type of the access hot spot is identified, and when the access hot spot is an access hot spot of a first authentication type, whether it is the first-time access to the access hot spot or not is judged; if it is the first-time access to the access hot spot, the user is prompted to configure access information of the access hot spot, for example, the user is prompted to input an access hot spot account, a password and the like on the displayed interface as shown in FIG. 2b, and after the user input the corresponding configuration information and clicks the connection button, a dialling connection flow is started; and if the access hot spot is not the access hot spot of the first authentication type, the step of judging whether it is the first-time access to the access hot spot or not is skipped, and when the user clicks the connection button, dialling connection can be triggered.

A specific process of executing dialling access according to the selection of the user is further described below by taking an ANDROID intelligent terminal and a China Telecom hot spot as an example.

On a WIFI hot spot selection interface as shown in FIG. 2a, when the user selects a hot spot of a home gateway type, such as a ChinaNet-TQRX hot spot, the user is prompted that the hot spot is a home gateway hot spot, and it is necessary to execute PPPOE dialling. A WIFI hot spot list is searched for to prepare for the dialling access flow, whether there is the China Telecom hot spot in the WIFI hot spot list or not is judged, and if the China Telecom hot spot is not in the WIFI hot spot list, a rapid dialling access flow ends, and the system resources are released. If the China Telecom hot spot is in the WIFI hot spot list, information of each hot spot is queried, the China Telecom hot spot is picked up, and is classified according to an applicable authentication type, and hot spot configuration information is loaded. The interface display module displays the corresponding user interface according to the authentication of the hot spot and the configuration information. Whether the user clicks the connection button on the interface or not is judged, and if the user does not click the connection button, the device waits for an instruction of the user. If the user clicks the connection button, it is judged whether the hot spot picked up by the user is a PPPOE hot spot or not, and if it is a PPPOE hot spot, on the interface as shown in FIG. 2b, the authentication type is set to be PPPOE, and the required configuration information such as a username and the password is loaded; the dialling access module executes dialling authentication access, and feeds back status information and the like to the user interface display module, and the interface as shown in FIG. 2d is displayed; and when this hot spot is to be connected again, there is no need to display this interface, and an automatic connection can be performed once the connection button is clicked. If the hot spot picked up by the user is not a PPPOE hot spot, on the interface as shown in FIG. 2c, the authentication type is set to be C+W, the configuration information required by C+W authentication is prepared, the dialling access module executes dialling authentication access, and feeds back the status information and the like to the user interface display module, and the interface shown in FIG. 2d is displayed.

According to the embodiment, by the method of executing dialling access according to the selection of the user, the beneficial effect of flexibly realizing dialling connection according to the actual configuration of the user is achieved, the problem that the user located in the environment without the related hot spot cannot access the Internet is solved, and the user experience is further improved.

The above is only the preferred embodiments of the disclosure and thus not intended to limit the scope of the disclosure, and the direct or indirect application of equivalent structures or equivalent flow transformations made by virtue of the description and drawings of the embodiment of the disclosure to other related arts shall similarly fall within the scope of protection of the embodiment of the disclosure.

What is claimed is:

1. A dialling method, comprising:
acquiring a list of hot spots, and setting strategy configuration information corresponding to the hot spots;
displaying a user interface for user selection according to the strategy configuration information; and
executing dialling access according to the selection of the user.

2. The dialling method according to claim 1, further comprising:
during a dialling access process, displaying dialling connection status prompt information in real time.

3. The dialling method according to claim 1, wherein acquiring the list of hot spots and setting the strategy configuration information corresponding to the hot spots comprises:
when the list of hot spots comprises a plurality of types of hot spots, performing authentication classification on the hot spots according to a preset rule; and
setting strategy configuration information corresponding to the hot spots according to authentication types.

4. The dialling method according to claim 1, wherein executing dialling access according to the selection of the user comprises:
searching the list of hot spots for an access hot spot selected by the user;
if there is the access hot spot selected by the user in the list of hot spots, picking up the access hot spot, and loading the strategy configuration information corresponding to the access hot spot;
displaying a current user interface according to the strategy configuration information corresponding to the access hot spot; and
triggering dialling connection according to the authentication type of the access hot spot when the user clicks a connection button.

5. The dialling method according to claim 4, wherein triggering dialling connection according to the authentication type of the access hot spot when the user clicks the connection button comprises:
when the access hot spot is an access hot spot of a first authentication type, judging whether it is a first-time access to the access hot spot or not;
if it is the first-time access to the access hot spot, prompting the user to configure access information of the access hot spot; and
otherwise triggering dialling connection when the user clicks the connection button.

6. A dialling device, comprising: a hot spot strategy selection module, an interface display module and a dialling access module,
wherein the hot spot strategy selection module is configured to acquire a list of hot spots, and set strategy configuration information corresponding to the hot spots;
wherein the interface display module is configured to display a user interface for user selection according to the strategy configuration information set by the hot spot strategy selection module; and
wherein the dialling access module is configured to execute dialling access according to the selection of the user.

7. The dialling device according to claim 1, wherein the interface display module is further configured to, during a dialling access process, display dialling connection status prompt information in real time.

8. The dialling device according to claim 6, wherein the hot spot strategy selection module is configured to, when the list of hot spots comprises a plurality of types of hot spots, perform authentication classification on the hot spots according to a preset rule, and set strategy configuration information corresponding to the hot spots according to authentication types.

9. The dialling device according to claim 6, wherein the dialling access module comprises:
an access hot spot searching unit, configured to search the list of hot spots for an access hot spot selected by the user;
a configuration information loading unit, configured to, if there is the access hot spot selected by the user in the list of hot spots, pick up the access hot spot, and load the strategy configuration information corresponding to the access hot spot; and
a dialling connection unit, configured to trigger dialling connection according to the authentication type of the access hot spot when the user clicks a connection button; and
the interface display module is further configured to display a current user interface according to the strategy configuration information of the access hot spot.

10. The dialling device according to claim 9, wherein the dialling connection unit is configured to, when the access hot spot is an access hot spot of a first authentication type, judge whether it is a first-time access to the access hot spot or not; if it is the first-time access to the access hot spot, prompt the user to configure access information of the access hot spot; otherwise trigger dialling connection when the user clicks the connection button.

11. The dialling method according to claim 2, wherein acquiring the list of hot spots and setting the strategy configuration information corresponding to the hot spots comprises:
when the list of hot spots comprises a plurality of types of hot spots, performing authentication classification on the hot spots according to a preset rule; and
setting strategy configuration information corresponding to the hot spots according to authentication types.

12. The dialling method according to claim 2, wherein executing dialling access according to the selection of the user comprises:
searching the list of hot spots for an access hot spot selected by the user;
if there is the access hot spot selected by the user in the list of hot spots, picking up the access hot spot, and loading the strategy configuration information corresponding to the access hot spot;
displaying a current user interface according to the strategy configuration information corresponding to the access hot spot; and
triggering dialling connection according to the authentication type of the access hot spot when the user clicks a connection button.

13. The dialling method according to claim 12, wherein triggering dialling connection according to the authentication type of the access hot spot when the user clicks the connection button comprises:
when the access hot spot is an access hot spot of a first authentication type, judging whether it is a first-time access to the access hot spot or not;
if it is the first-time access to the access hot spot, prompting the user to configure access information of the access hot spot; and
otherwise triggering dialling connection when the user clicks the connection button.

14. The dialling device according to claim 7, wherein the hot spot strategy selection module is configured to, when the list of hot spots comprises a plurality of types of hot spots, perform authentication classification on the hot spots according to a preset rule, and set strategy configuration information corresponding to the hot spots according to authentication types.

15. The dialling device according to claim 7, wherein the dialling access module comprises:
an access hot spot searching unit, configured to search the list of hot spots for an access hot spot selected by the user;
a configuration information loading unit, configured to, if there is the access hot spot selected by the user in the list of hot spots, pick up the access hot spot, and load the strategy configuration information corresponding to the access hot spot; and
a dialling connection unit, configured to trigger dialling connection according to the authentication type of the access hot spot when the user clicks a connection button; and
the interface display module is further configured to display a current user interface according to the strategy configuration information of the access hot spot.

16. The dialling device according to claim 15, wherein the dialling connection unit is configured to, when the access hot spot is an access hot spot of a first authentication type, judge whether it is a first-time access to the access hot spot or not; if it is the first-time access to the access hot spot, prompt the user to configure access information of the access hot spot; otherwise trigger dialling connection when the user clicks the connection button.
